(19) United States
(12) Patent Application Publication
(10) Pub. No.: US 2025/0153959 A1
(43) Pub. Date: May 15, 2025

(54) Seed on Demand System

(71) Applicant: Amazonen-Werke H. Dreyer SE & Co. KG, Hasbergen (DE)

(72) Inventors: Jan-Eike LUEBBEN, Edewecht (DE); Thomas WIEN, Stuhr (DE)

(73) Assignee: Amazonen-Werke H. Dreyer SE & Co. KG, Hasbergen (DE)

(21) Appl. No.: 18/836,570

(22) PCT Filed: Jan. 30, 2023
(86) PCT No.: PCT/EP2023/052108

§ 371 Date: Aug. 7, 2024

(30) Foreign Application Priority Data
Feb. 7, 2022 (DE) 10 2022 102 744.9

(51) Int. Cl. B65G 53/50; A01C 15/00; A01C 15/04; B65G 53/10

(52) U.S. Cl. CPC B65G 53/50; A01C 15/04; B65G 53/10; A01C 15/006

(57) ABSTRACT

Seed on-demand system for granular material comprising at least one storage container for granular material, at least one fan to provide a conveyor air flow, and a distributing device with a distributor housing which is designed to receive material from the storage container by means of a material inlet opening and has a conveyor air opening to direct the conveyor air flow in the direction of the material received to generate a mixed flow of conveyor air and material, and at least one distributing segment which forms at least one first conduit with a first receiving opening and a first outlet opening, wherein the conduit is arranged to receive at least a part of the mixed flow by means of the receiving opening and to discharge it from the outlet opening. To avoid disturbances in the distribution of the material and simultaneously generate the mixed flow in an energy-efficient manner, it is provided that at least one stirring element is arranged between the material inlet opening and the first receiving opening to loosen the material in the area where the conveyor air flow is directed onto the material.

### CROSS REFERENCE TO RELATED APPLICATIONS

The present application claims priority under 35 U.S.C. § 365 to PCT/EP2023/052108 filed on Jan. 30, 2023 and under 35 U.S.C. § 119 (a) to German Application No. 10 2022 102 744.9 filed on Feb. 7, 2022.

### BACKGROUND

The disclosure relates to a seed on-demand system.

A seed on-demand system in such a way is described in U.S. Pat. No. 7,182,029 B2. These systems are used in seed drills to distribute granular material from a central storage container to decentralized application devices. For this purpose, the seed on-demand system comprises the storage container for the granular material, at least one fan to provide a conveyor air flow, and a distributing device. The distributing device has a distributor housing that is designed to receive material from the storage container by means of a material inlet opening. Furthermore, the distributor housing has a conveyor air opening for conducting the conveyor air flow in the direction of the material picked up in order to generate a mixed flow of conveyor air and material. In addition, the distributing device has a distributing segment that forms at least one conduit with a receiving opening and an outlet opening, wherein the conduit is arranged to receive at least part of the mixed flow by means of the receiving opening and to discharge it from the outlet opening.

As the mixed flow of conveyor air and material in seed on-demand systems of this kind has to be generated solely by the energy of the conveyor air flow, problems have arisen in the prior art if the granular material, in particular seed and/or fertilizer, is sticky, for example due to the influence of moisture or the use of mordant. At times, this results in undesirable intermittent conveying or the distribution of material breaks down completely.

### SUMMARY

The object underlying the disclosure is thus to avoid disturbances in the distribution of the material and simultaneously generate the mixed flow in an energy-efficient manner.

This object is solved by a seed on-demand system having the features of claim 1. Further advantageous embodiments and further embodiments of the disclosure are given in the depending claims.

To solve the above object, the disclosure proposes a seed on-demand system for granular material comprising a storage container for granular material, at least one fan to provide a conveyor air flow, and a distributing device. The distributing device has a distributor housing that is designed to receive material from the storage container by means of a material inlet opening. The material inlet opening may be arranged at the top of the distributor housing so that the material slides into the distributor housing under the effect of gravity. The distributor housing also has at least one conveyor air opening to direct the conveyor air flow in the direction of the material being picked up, so that a mixed flow of conveyor air and material is generated. The at least one conveyor air opening is arranged in particular in such a way that granular material is whirled up and entrained with the conveyor air flow without the need for an actively driven metering element that feeds material into the conveyor air flow in controlled quantities. In this respect, the dosing method of the distributing device may also be designated as automatic. In the seed on-demand system according to the disclosure, the conveyor air flow is thus not only responsible for conveying the material but also for dosing it.

The distributing device further comprises at least one distributing segment, which forms at least a first conduit with a first receiving opening and a first outlet opening. The conduit is arranged in such a way that at least a portion of the mixed flow enters the receiving opening, in particular automatically, and may be discharged from the outlet opening. Preferably, the receiving opening is arranged in the area where material is swirled in the conveyor air flow, thus creating the mixed flow, so that the mixed flow may enter the conduit directly and easily.

In order to loosen the material in the area where the conveyor air flow is directed onto the material, at least one stirring element is arranged between the material inlet opening and the first receiving opening. The stirring element is thus arranged in the direction of flow of the material on the path from the material inlet opening to the receiving opening. The disclosure makes use of the realization that the use of a stirring element considerably facilitates the generation of the mixed flow. On the one hand, clumping and sticky material is broken up so that it may be more easily swirled by the conveyor air flow and enter the receiving opening as a mixed flow. On the other hand, the mixed flow is homogenized so that the overall distribution of material is more even. The conveyor air flow therefore requires less energy, which improves the efficiency of the seed on-demand system and at the same time increases its functional reliability. In particular, if the material enters the distributor housing under gravity and, unlike in systems with an active dosing element, the material is poured in the lower area, bridging of the material may be effectively prevented.

The use of a passive, i.e. non-driven, stirring element is conceivable. The stirring element preferably has a distance from the receiving opening that corresponds at least to the clear diameter of the receiving opening. A passive stirring element may be designed so that part of the material picked up is directed over the stirring element and part under the stirring element, so that the bulk material is loosened. The stirring element may have at least approximately the same distance to one, in particular outer, side wall of the distributor housing as to the receiving opening.

In a preferred embodiment of the seed on-demand system according to the disclosure, the stirring element is drivable in rotation about a rotation axis. Preferably, the rotation axis has a distance from the receiving opening that corresponds to at least twice the radius of the stirring element. The stirring element may be adapted in a whisk-like manner. The stirring element may be a shaft with stirring fingers, wherein the radius of the stirring element may correspond to the radius of the shaft or the radius of the fingers. The drive speed of the stirring element may be independent of the travel speed of the seed on-demand system. The drive mode may be intermittent. In particular, the stirring element may be powered when the seed on-demand system is stationary and/or may be stationary at least intermittently while the seed on-demand system is being used to actively distribute granular material.

In a further particularly advantageous further development of the seed on-demand system according to the disclosure, the rotation axis has at least the same distance to one, in particular outer, side wall of the distributor housing as to the receiving opening. The rotation axis may be arranged equidistant to the receiving opening and to the side wall. As a result of this further development, the risk of bridging and blockages is further reduced.

In a preferred embodiment of the seed-on-demand system according to the disclosure, the distributing segment has at least two conveyor air openings whose directions in which the conveyor air flow is emitted enclose an angular range of less than 180 degrees, wherein the stirring element at least temporarily passes through the angular range. Preferably, the stirring element has stirring fingers which comb through the angular region at least temporarily, particularly preferably when the stirring element is powered in rotation. The directions in which the conveyor air is discharged from the conveyor air openings are decisive for the grain pick-up area, so that as a result of this measure the grain pick-up area, which corresponds to the enclosed angular area, is loosened up by the stirring element and thus improved.

In order to distribute the granular material to a plurality of spreading devices, the seed on-demand system may have a plurality of distributing segments arranged next to each other on an axis. A particularly simple and practical design of the stirring element is achieved by the stirring element being designed as a stirring shaft which extends parallel to the axis.

In a further advantageous development of the seed on-demand system, it is provided that a distributing segment forms at least one second conduit with a second receiving opening and a second outlet opening. Preferably, it is provided that at least one stirring element, in particular a further stirring element preferably designed as a stirring shaft, is arranged between the material inlet opening and the second receiving opening. Each stirring element may be assigned its own drive.

In a further advantageous embodiment of the disclosure, the conduit has a bypass opening between the receiving opening and the outlet opening in order to introduce a bypass flow of the conveyor air flow, wherein the bypass opening is arranged directly above the receiving opening. The bypass flow may therefore be introduced into the conduit without further flow obstacles or deflections in the flow direction of the mixed flow, which further increases energy efficiency. A first bypass opening may be arranged between the first receiving opening and the first outlet opening. A second bypass opening may be arranged between the second receiving opening and the second outlet opening. Preferably, the bypass openings are located horizontally next to each other so that the bypass flows are introduced into the respective conduit at the same height above the receiving opening. This also homogenizes the flow.

In a further advantageous embodiment of the seed on-demand system according to the disclosure, a common drive is provided which is designed to power both stirring elements, in particular stirring shafts. A chain or belt and/or at least two drive elements, such as gear wheels, may be provided for this purpose. In an expedient manner, only a single powering device is thus required for two stirring elements. Another advantage is that both stirring elements may preferably be powered in the same way. The drive may be powered independently of the speed of the seed on-demand system. The powering may be intermittent, in particular the stirring elements may be powered when the seed on-demand system is stationary.

In order to facilitate the production of the distributing device, in particular a distributing segment, and to make it particularly economical, it is provided that the first conduit to the second conduit and/or the stirring elements are symmetrical with respect to a vertical axis of the distributing segment or a point on the vertical axis. A symmetrical arrangement of the first and second conduits with respect to each other relative to the vertical axis or a point on the vertical axis also improves the absorption of the mixed flow by means of the receiving openings. A symmetrical arrangement of the stirring elements as described above also ensures a particularly homogeneous generation of the mixed flow. Preferably, the first and second conduits and the stirring elements are arranged symmetrically to the same point on the vertical axis. Particularly preferably, the first and second conduits are arranged symmetrically to the stirring elements with respect to the vertical axis or a point on the vertical axis. There may be an axial symmetry to the vertical axis. There may be a point symmetry to the point on the vertical axis.

The homogenization of the mixed flow and thus the energy efficiency and functional reliability of the seed on-demand system is also advantageously increased by the fact that the stirring elements are arranged in a common horizontal plane. Since the gravity-induced slippage of granular material has a substantial effect on the turbulence caused by the conveyor air flow when generating the mixed flow, the arrangement of the stirring elements, in particular the stirring shafts, at the same height has proven to be particularly beneficial.

In a further advantageous development of the seed on-demand system according to the disclosure, it is provided that the stirring element extends between opposite end faces of the distributor housing, in particular through all distributing segments. The mounting of the stirring element in the end faces of the distributor housing allows easy assembling and functional testing.

The seed on-demand system according to the disclosure is further advantageously developed by at least one overpressure operated separating device for the granular material. The use of an overpressure operated separating device results in a special synergy with the stirring element: there is an overpressure in the separating device which ensures that granular material accumulates on a preferably rotating separating element. The granular material enters the separating device via the mixed flow, wherein the mixed flow also has a positive air pressure in order to convey the granular material. A separating air flow for separation may have a lower air pressure than the mixed flow. The conveying of the mixed flow occurs virtually against the air pressure of the separating air flow. Since at least the air pressure required to convey the granular material may be reduced as a result of the stirring element according to the disclosure, the pressure difference between the mixed flow and the separating air flow is reduced. The seed on-demand system is thus designed to be particularly efficient. Preferably, the seed on-demand system has at least as many separating devices as outlet openings. An energy reduction element, in particular a catch roller, may be assigned to the separating device for the isolated discharge of the granular material.

In a further advantageous development of the seed on-demand system according to the disclosure, it is provided that the stirring element is drivable in a rotatable manner about a rotation axis, wherein the rotational direction may be reversed, preferably within one revolution. As a result of this development, intermittent operation may be implemented, wherein the rotational direction changes after a predetermined number of revolutions, so that particularly good mixing is achieved. This is particularly advantageous to prevent bridging of dressed seeds. It is particularly preferable for the rotational direction to be reversible within one revolution, so that a pendulum movement is created.

### BRIEF DESCRIPTION OF THE DRAWINGS

Further details of the disclosure may be found in the example description and the drawings. The drawings show

FIG. 1 symbolic representation of a seed on-demand system according to the disclosure,

FIG. 2 a distributing device in perspective view,

FIG. 3 the distributing device according to FIG. 2 in a first sectional view,

FIG. 4 the distributing device according to FIG. 2 in a second sectional view, and

FIG. 5 the distributing device according to FIG. 2 in a third sectional view.

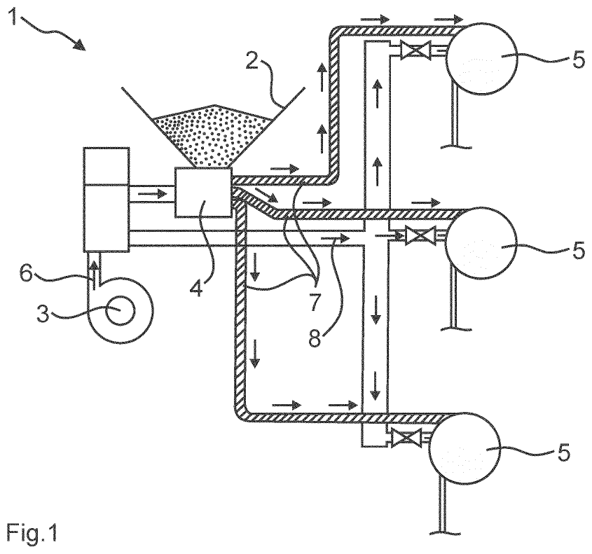

A seed on-demand system 1 for granular material according to the disclosure is shown symbolically in FIG. 1. The seed on-demand system 1 comprises a storage container 2, a fan 3 and a distributing device 4, as well as a plurality of overpressure operated separating devices 5, wherein for the sake of clarity only three separating devices 5 are shown here. The seed on-demand system 1 is intended to distribute granular material from the storage container 2 to the separating devices 5 by means of the distributing device 4 with the aid of the fan 3. For this purpose, a conveyor air flow 6 is provided by the fan 3, which swirls granular material in the distributing device 4 and thus generates a mixed flow 7. The granular material is made available to the separating devices 5 via the mixed flow 7. As shown in this figure, the distributing device 4 may be arranged below the storage container 2 so that the granular material slides down under the influence of gravity. The seed on-demand system 1 may comprise several storage containers 2 with an assigned distributing device 4. In addition, other than shown here, more than a single fan 3 may be provided to provide the conveyor air flow 6 and separating air flows 8. In an embodiment not shown, the seed on-demand system 1 has a separate fan for providing the conveyor air flow 6 and the separating air flows 8. The flow path characterized by the reference number 8 is fed from a second additional fan 3 in this embodiment not shown. The separating air flow 8 has a lower air pressure than the mixed flow 7.

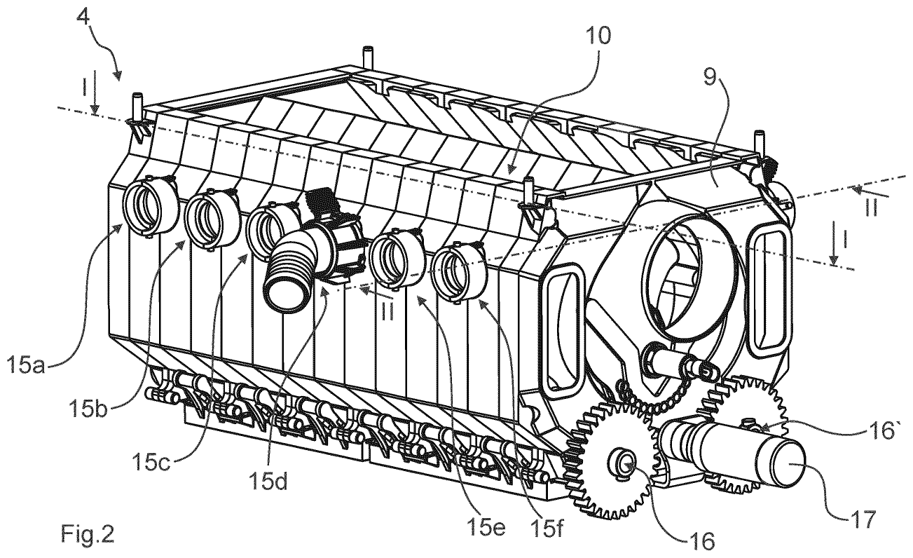

A perspective view of a distributing device 4 in such a way is shown in FIG. 2. The distributing device 4 has a distributor housing 9, which is designed to receive material from the storage container 2 by means of a material inlet opening 10 on its upper side. A circular air inlet is arranged at the front of the distributor housing 9 in order to introduce the conveyor air flow 6 into the distributor housing 9.

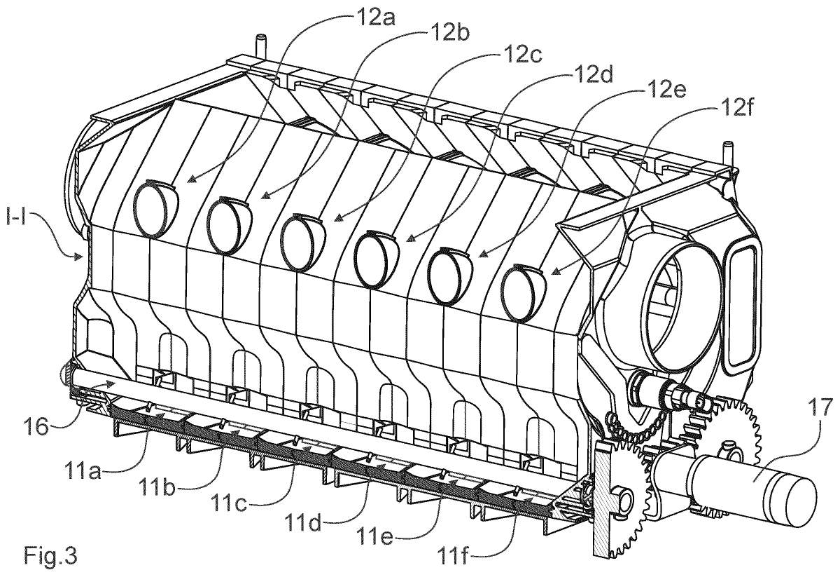

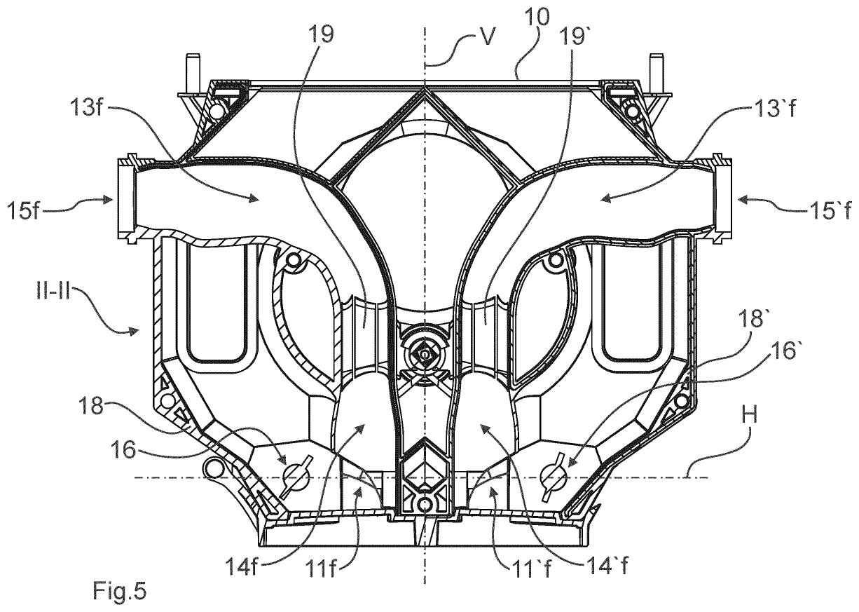

The conveyor air flow 6 is directed towards the material picked up by means of several conveyor air openings 11a-f in order to generate the mixed flows 7. The conveyor air openings 11a-f may be seen in sectional view I-I in FIG. 3. Here it is also clear that the distributing device 4 has several distributing segments 12a-f. Each of the distributing segments 12a-f has two conveyor air openings 11a-f, as may be seen in sectional view II-II in FIG. 5.

The distributing segments 12a-f each form a first conduit 13a-f and a second conduit 13′a-f. The conduits 13a-f, 13′a-f each have a receiving opening 14a-f, 14′a-f and an outlet opening 15a-f, 15′a-f. The conduits 13a-f, 13′a-f are arranged in such a way that the granular material is automatically taken up through the receiving openings 14a-f, 14′a-f after being swirled by the conveyor air flow 6, i.e. as a mixed flow 7, rises and is finally discharged from the outlet openings 15a-f, 15′a-f. In order to improve the generation and receiving of the mixed flows 7 described above, a stirring element designed as a stirring shaft 16 is arranged between the material inlet opening 10 and the first receiving opening 14a-f. The stirring shaft 16 loosens the material in the area where the conveyor air flow 6 is directed onto the material. The stirrings shaft 16 is arranged in the direction of flow of the material from the material inlet opening 10 to the receiving openings 14a-f, 14′a-f between these two openings. On the opposite side of the distributing segments 12a-f, a further stirring shaft 16′ is arranged between the material inlet opening 10 and the second receiving openings 14′a-f.

A common drive 17 is assigned to the stirring shafts 16, 16′ in order to drive them rotatably about their rotation axis. The rotational direction of the stirring shafts 16, 16′ may be reversed, in particular within one revolution, in order to increase the mixing effect and prevent bridging. In the illustrated embodiment of the seed on-demand system, the drive 17 is in drive connection with the two stirring shafts 16, 16′ via gear wheels, so that, assuming the gear wheels have the same transmission ratio, the stirring shafts 16, 16′ are drivable in the same way. The drive may be powered independently of a travel speed and/or in intervals. As an alternative to the gearwheels, a drive connection via at least one chain, belt or the like is also conceivable.

As may be seen in FIG. 5, the first and second conduits 13a-f, 13′a-f and the stirring shafts 16, 16′ are arranged symmetrically with respect to a vertical axis V. In particular, the first and second conduits 13a-f, 13′a-f and the stirring shafts 16, 16′ are arranged symmetrically relative to one, preferably every, point on the vertical axis V. Also clearly visible in this sectional view II-II, see FIG. 2, is that the stirring shafts 16, 16′ are arranged in a common horizontal plane H and their rotation axis has a distance from the receiving opening 14f, 14′f which corresponds to at least twice the radius of the stirring shaft 16, 16′. As tests have shown, this distance represents an optimum compromise between an arrangement close to the grain receiving opening and sufficient distance to avoid bridging, so that the loosening of the granular material close to the receiving opening 14a-f, 14′a-f is improved. Furthermore, the rotation axes of the stirring shafts 16, 16′, which in FIG. 5 run perpendicular to the cutting or image plane, have at least the same distance to the side walls 18, 18′ as to the respective receiving opening 14a-f, 14′a-f. Such an at least equidistant arrangement of the stirring shafts 16, 16′ further reduces the tendency to bridge formation and thus contributes to the functional reliability of the distributing device 4 even when the stirring shafts 16, 16′ are idle.

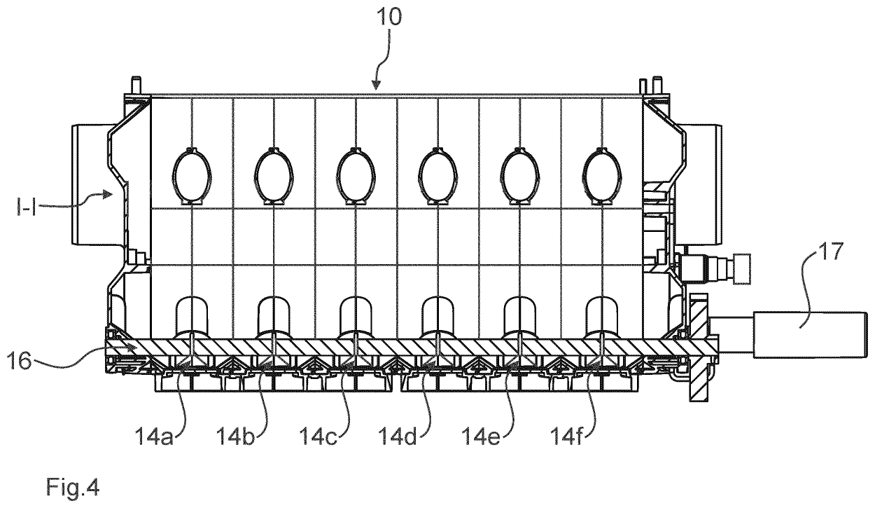

The stirring shafts 16, 16′ extend between opposite end faces of the distributor housing 9 through all distributing segments 12a-f, as shown in FIGS. 3 and 4. The distributing segments 12a-f are arranged side by side on one axis, wherein the stirring shafts 16, 16′ are arranged parallel to this axis. Each distributing segment (12a-f) has two conveyor air openings (11a-f, 11′a-f) on opposite sides, the directions in which the conveyor air flow (6) is emitted enclosing an angular range of less than 180 degrees, wherein the stirring element (16) at least temporarily sweeps through the angular range.

The operation of the distributing device 4 may be clearly explained using the sectional view II-II through the distributing segment 12f, shown in FIG. 5. The granular material slides into the distributor housing 9 from above via the material inlet opening 10 and splits to the left and right via the upwardly directed wedge, which serves to feed the conveyor air flow 6 to the conveyor air openings 11a-f, 11′a-f. In the lower part of the distributor housing 9, a fill is formed in front of the conveyor air openings 11a-f, 11′a-f and the receiving openings 14a-f, 14′a-f on the inclined side walls 18, 18′. The conveyor air flow 6 emerging from the conveyor air openings 11f, 11′f is directed towards the granular material, which is loosened by the stirring shafts 18, 18′—the turbulence of the granular material and the generation of the mixed flow 7 is thus improved. The mixed flow 7 enters the receiving openings 14f, 14′f and rises in the conduits 13f, 13′f. The conduits 13a-f, 13′a-f each have a bypass opening 19, 19′ between the receiving opening 14a-f, 14′a-f and the outlet opening 15a-f, 15′a-f in order to introduce a bypass flow of the conveyor air flow 6. The bypass openings 19, 19′ are arranged directly above the receiving openings 14a-f, 14′a-f, so that the bypass flow is introduced without deflecting the bypass flow and the rising mixed flow 7. The bundled flow from a mixed flow 7 and a bypass flow then continue to rise in the conduits 13f, 13′f and leave them via the outlet openings 15f, 15′f. The material is then distributed from the outlet openings 15f, 15′f to the overpressure operated separating devices 5.

As the grain absorption is improved as a result of the arrangement of stirring elements designed as stirring shafts 16, 16′, the mixed flow 7 has a reduced air pressure. This is particularly advantageous because the separating air flow 8 has a lower air pressure than the mixed flow 7 and may therefore also be generated with reduced energy input. The seed on-demand system 1 is thus not only improved in terms of its functional reliability but also its energy efficiency. —LIST OF REFERENCE SIGNS
1 Seed on-demand system
2 Storage container
3 Fan
4 Distributing device
5 Separating device
6 Conveyor air flow
7 Mixed flow
8 Separating air flow
9 Distributor housing
10 Material inlet opening
11a-f, 11′a-f Conveyor air opening
12a-f Distributing segment
13a-f, 13′a-f Conduit
14a-f, 14′a-f Receiving opening
15a-f, 15′a-f Outlet opening
16, 16′ Stirring shaft
17 Drive
V Vertical axis
H Horizontal plane
18, 18′ Side wall
19, 19′ Bypass opening

1. A seed on-demand system for granular material comprising:
at least one storage container for granular material,
at least one fan to provide a conveyor air flow, and
a distributing device having a distributor housing which is designed to receive material from the storage container by means of a material inlet opening and has a conveyor air opening to direct the conveyor air flow in the direction of the received material to generate a mixed flow of conveyor air and material, and at least one distributing segment, which forms at least one first conduit with a first receiving opening and a first outlet opening, wherein the conduit is arranged to receive at least a part of the mixed flow by the receiving opening and to discharge it from the outlet opening, wherein at least one stirring element is arranged between the material inlet opening and the first receiving opening to loosen the material in the area where the conveyor air flow is directed onto the material.

2. The seed on-demand system according to claim 1, wherein the stirring element is drivable in rotation about a rotation axis, wherein the rotation axis has a distance from the receiving opening which corresponds to at least twice the radius of the stirring element.

3. The seed on-demand system according to claim 2, wherein the rotation axis has at least the same distance from one, in particular outer, side wall of the distributor housing as from the receiving opening.

4. The seed on-demand system according to claim 1, wherein the distributing segment has at least two conveyor air openings, whose directions in which the conveyor air flow is emitted enclose an angular range of less than 180 degrees, such that the stirring element at least temporarily passes through the angular range.

5. The seed on-demand system according to claim 1, characterized by a plurality of distributing segments which are arranged next to each other on an axis, wherein the stirring element is designed as a stirring shaft which extends parallel to the axis.

6. The seed on-demand system according to claim 1, wherein the conduit has a bypass opening between the receiving opening and the outlet opening to introduce a bypass flow of the conveyor air flow, characterized in that the bypass opening is arranged directly above the receiving opening.

7. The seed on-demand system according to claim 1, characterized in that a distributing segment forms at least one second conduit with a second receiving opening and a second outlet opening, that at least one, in particular further, stirring element, preferably designed as a stirring shaft, is arranged between the material inlet opening and the second receiving opening.

8. The seed on-demand system according to claim 7, further including a common drive designed to power both stirring elements, in particular stirring shafts.

9. The seed on-demand system according to claim 7, wherein the first conduit is symmetrical with respect to the second conduit and/or the stirring elements is and/or are symmetrical with respect to a vertical axis of the distributing segment or a point on the vertical axis.

10. The seed on-demand system according to claim 7, wherein the stirring elements are arranged in a common horizontal plane.

11. The seed on-demand system according to claim 1, characterized in that stirring elements extend between opposite end faces of the distributor housing, in particular through all distributing segments.

12. The seed on-demand system according to claim 1, further including at least one overpressure operated separating device for the granular material.

13. The seed on-demand system according to claim 12, further including a separating air flow for separating by the separating device has a lower air pressure than the mixed flow.

14. The seed on-demand system according to claim 1, wherein the stirring element is drivable in rotation about a rotation axis, wherein the rotational direction is reversible, preferably within one revolution.
